(19) United States
(12) Patent Application Publication
(10) Pub. No.: US 2002/0001403 A1
(43) Pub. Date: Jan. 3, 2002

(54) Focusing control mechanism, and inspection apparatus using same

(75) Inventor: Hiroki Kikuchi, Kanagawa (JP)

Correspondence Address: David R. Metzger, Esq., SONNENSCHEIN NATH & ROSENTHAL, P.O. Box 061080, Wacker Drive Station, Sears Tower, Chicago, IL, 60606-1080, US

(73) Assignee: SONY CORPORATION

(21) Appl. No.: 09/862,557

(22) Filed: May 22, 2001

(30) Foreign Application Priority Data
May 25, 2000 (JP) P2000-155403

(51) Int. Cl. G06K 9/00; G06K 9/40

(52) U.S. Cl. 382/145; 382/255

(57) ABSTRACT

To properly focus an ultraviolet objective lens by the use of a distance sensor even when inspecting an object having a larger step than the focal depth of the objective lens, a difference between the real shape of a convex or concave pattern in each of dies formed on a semiconductor wafer 100 to be inspected and the shape (false shape) of a convex or concave pattern the distance sensor 8 recognizes, is calculated as a correction value C2 intended for use to compensate for an influence of the step in the die. The output from the distance sensor 8 is compensated with the correction value C2 to determine an accurate target moving distance, and an inspection stage 2 is driven accordingly to the target moving distance to automatically focus the ultraviolet objective lens.

### BACKGROUND OF THE INVENTION

1. Field of the Invention

The present invention relates to a focusing control mechanism which focuses an objective lens used in observing an object under inspection and an inspection apparatus which inspects an object under inspection such as a semiconductor device ans the like using the focusing control mechanism to focus the objective lens on the object.

2. Description of the Related Art

The semiconductor device is produced by forming a fine device pattern on a semiconductor wafer. In the process of producing the semiconductor device, for example a foreign matter adhering to the device pattern or a dimensional anomaly taking place in the device pattern will be a defect of the device pattern. Of course, the semiconductor device having such a defect of the device pattern is not acceptable. To stabilize the yield in such a process of semiconductor device production at a high level, it is necessary to early detect such a defect in the device pattern, locate its cause and take an effective corrective action to the production process.

To this end, if a defect takes place in a device pattern, an inspection apparatus is used to check for the defect, locate its cause and find the source of the defect in the production equipment and process. Typically, to diagnose such a device pattern defect, a so-called inspection apparatus using an optical microscope is used in which an illumination light is projected to a part of the device pattern where the defect has occurred and the image of the part is viewed as enlarged in scale by an objective lens for observation.

However the device patterns of the semiconductor devices have trended finer and finer, and recently a design rule for a wire width of less than 0.18 μm has been applied to the semiconductor device patterns. With such a finer design pattern, it has come necessary to use an inspection apparatus which can check for fine defects which have ever been negligible.

To properly check for such fine defects, it has been tried to use a light having a wavelength falling within the ultraviolet domain as an illumination light in the inspection apparatus. Using an ultraviolet light having a short wavelength, the inspection apparatus can inspect an object with a higher resolution than when a visible light is used as the illumination light and thus can properly check for fine defects.

When an ultraviolet light is used as the illumination light, a lens designed to show an optimum imaging characteristic to the ultraviolet light has to be used as an objective lens. The objective lens for the ultraviolet light has an extremely small depth of focus. When the ultraviolet light has a wavelength of 266 nm for example, an ultraviolet objective lens having a numerical aperture (NA) of 0.9 and an imaging magnification of 100 will have a focal depth of about ±0.16 μm.

When the above inspection apparatus employing such an objective lens is used to check a semiconductor device pattern for any defect, the objective lens has to be focused. However, since the focal depth is very small, it is extremely difficult to manually focus the objective lens. Also, the manual focusing of the objective lens for each inspection will take a long time, which will be disadvantageous from the economic standpoint. Hence, an inspection apparatus using an ultraviolet light as the illumination light has to be equipped with a high-precision focusing mechanism which can focus the objective lens accurately and quickly in an automatic, not manual, manner.

As such an automatic focusing mechanism for the ultraviolet objective lens, there has been proposed a one in which a distance measuring light is incident upon the objective lens, a reflected light from an object under inspection is detected and the objective lens is focused based on changes in position of a reflective source and light amount. Generally, with an influence to an object to be inspected and costs taken in consideration, this inspection apparatus adopts a laser diode which emits a visible light or near-infrared wavelength laser light as a source of a distance measuring light.

However, it is very difficult to use the above focusing mechanism in the inspection apparatus using an ultraviolet light as the illumination light. More particularly, since a lens designed to show an optimum imaging characteristic to the ultraviolet light as mentioned above is used as the objective lens in the inspection apparatus using the ultraviolet light as the illumination light, a chromatic aberration will take place when a visible light or a near-infrared wavelength laser light is incident upon the objective lens so that a plane in which the light is focused by the objective lens will be largely off a one in which the ultraviolet light incident upon the lens is focused by the lens. Thus the objective lens cannot properly be focused. Also, it may be possible to use, as the objective lens, a lens whose chromatic aberration is corrected to both the ultraviolet light used as the illumination light and the visible light or infrared wavelength laser light used as the distance measuring light. However, such a lens is extremely difficult to produce and could be produced with a very large cost, and it is normally constructed from different types of glass materials attached to each other with an adhesive which however will easily be deteriorated due to the ultraviolet light.

For automatically focusing the ultraviolet objective lens, there is under review a method in which a distance sensor such as a capacitance senor is provided near the objective lens and used to measure a distance between the objective lens and an object under inspection, and the objective lens or object is moved based on the result of the measurement.

In some types of device patterns, one die (a part which will be an individual chip) has developed therein a step which further larger than the depth of focus of the ultraviolet objective lens. There can be a case where in an LSI (large scale integrated) circuit board in which a DRAM and logic are combined on a single chip, for example, the DRAM part is so convex than the logic part that the step between them is larger than 1 μm. On the other hand, the distance sensor normally means an area of about 3 mm in diameter and detects a mean distance within this measuring area as a distance between the objective lens and an object under inspection. Therefore, when the above distance sensor is used to automatically focus the ultraviolet objective lens in inspection of a semiconductor wafer in which the LSI where the DRAM and logic are combined on the single chip, if the boundary between the DRAM and logic enters the measuring area of the distance sensor, the distance sensor cannot accurately detect the distance to the semiconductor wafer and thus the objective lens cannot properly be focused.

### OBJECT AND SUMMARY OF THE INVENTION

Accordingly, the present invention has an object to overcome the above-mentioned drawbacks of the prior art by providing a focusing control mechanism using a distance sensor and capable of properly focusing an objective lens even if an object having a larger step than the focal depth of the objective lens, and an inspection apparatus using the focusing control mechanism.

The above object can be attained by providing a focusing control mechanism for focusing an objective lens when observing an object under inspection using the objective lens, including according to the present invention:

a distance sensor provided in a fixed geometric relation to the objective lens;

a storage means for storing data representing the shape of a convex or concave pattern of the object under inspection and data representing a spatial sensitivity distribution of the distance sensor;

means for moving either or both of the objective lens and object under inspection relatively in direction towards or away from each other; and

means for controlling the operation of the moving means;

the controlling means calculating, based on the data representing the shape of convex or concave pattern of the object under inspection and data representing the spatial sensitivity distribution of the distance sensor, both stored in the storage means, a deviation of the shape of a convex or concave pattern recognized by the distance sensor from the shape of the actual convex or concave pattern, to provide a correction value, compensating for an output from the distance sensor with the correction value to determine a target moving distance, and controlling the operation of the moving means according to the target moving distance.

When focusing the objective lens by means of the focusing control mechanism, first a distance between the objective lens and object under inspection is measured by the distance sensor. If the object under inspection has a convex or concave pattern and the convex or concave pattern exists within the measuring area of the distance sensor, the shape of a convex or concave pattern recognized by the distance sensor deviates from that of actual convex or concave pattern due to the convex or concave shape of the pattern within the measuring area of the distance sensor, as the case may be.

The output of the distance sensor is supplied to the controlling means. The controlling means will calculate, based on the data representing the shape of convex or concave pattern of the object under inspection and data representing the spatial sensitivity distribution of the distance sensor, both stored in the storage means, a deviation of the shape of a convex or concave pattern recognized by the distance sensor from the shape of actual convex or concave pattern. Then the controlling means will compensate for the output from the distance sensor with the calculated correction value to determine a target moving distance, and control the operation of the moving means according to the target moving distance.

The moving means operates under the control of the controlling means to move either or both of the objective lens and object under inspection relatively in a direction towards or away from each other over the target moving distance. Thus, the distance between the objective lens and object under inspection is controlled to focus the objective lens.

Also the above object can be attained by providing an inspection apparatus including according to the present invention:

an illuminating means for illuminating an object under inspection with an illumination light converged by an objective lens;

an imaging means for imaging the object under inspection, illuminated by the illuminating means;

an inspecting means for processing an image picked up by the imaging means to inspect the object under inspection;

a distance sensor provided in a fixed geometric relation to the objective lens;

a storage means for storing data representing the shape of a convex or concave pattern of the object under inspection and data representing a spatial sensitivity distribution of the distance sensor;

means for moving either or both of the objective lens and object under inspection relatively in direction towards or away from each other; and

means for controlling the operation of the moving means;

the controlling means calculating, based on the data representing the shape of convex or concave pattern of the object under inspection and data representing the spatial sensitivity distribution of the distance sensor, both stored in the storage means, a deviation of the shape of a convex or concave pattern recognized by the distance sensor from the shape of actual convex or concave pattern, to provide a correction value, compensating for an output from the distance sensor with the correction value to determine a target moving distance, and controlling the operation of the moving means according to the target moving distance.

When inspecting an object under inspection using the inspection apparatus, the object is illuminated with the illumination light converged by the objective lens. The object thus illuminated with the illumination light is imaged by the imaging means.

At this time, the objective lens is focused. For the focusing of the objective lens, first a distance between the objective lens and object under inspection is measured by the distance sensor. If the object under inspection has a convex or concave pattern and the convex or concave pattern exists within the measuring area of the distance sensor, the shape of a convex or concave pattern recognized by the distance sensor deviates from that of actual convex or concave pattern due to the convex or concave shape of the pattern within the measuring area of the distance sensor, as the case may be.

The output of the distance sensor is supplied to the controlling means. The controlling means will calculate, based on the data representing the shape of convex or concave pattern of the object under inspection and data representing the spatial sensitivity distribution of the distance sensor, both stored in the storage means, a deviation of the shape of a convex or concave pattern recognized by the distance sensor from the shape of actual convex or concave pattern. Then the controlling means will compensate for the output from the distance sensor with the calculated correction value to determine a target moving distance, and control the operation of the moving means according to the target moving distance.

The moving means operates under the control of the controlling means to move either or both of the objective lens and object under inspection relatively in a direction towards or away from each other over the target moving distance. Thus, the distance between the objective lens and object under inspection is controlled to focus the objective lens.

With the objective lens having thus been focused, the image of the object, picked up by the imaging means, is supplied to the inspecting means. The inspecting means will process the image picked up by the imaging means to inspect the object under inspection.

These objects and other objects, features and advantages of the present intention will become more apparent from the following detailed description of the preferred embodiments of the present invention when taken in conjunction with the accompanying drawings.

### BRIEF DESCRIPTION OF THE DRAWINGS

FIG. 1 is a schematic block diagram of the inspection apparatus according to the present invention;

FIG. 2 shows the construction of an inspection stage provided in the inspection apparatus shown in FIG. 1;

FIG. 3 shows an optical unit provided in the inspection apparatus shown in FIG. 1;

FIG. 4 is a view, enlarged in scale, of a portion, near a distance sensor, of the inspection apparatus;

FIG. 5 is a block diagram of a control computer provided in the inspection apparatus, showing an example construction thereof;

FIG. 6 is a flow chart of operations effected in inspection of a semiconductor wafer by the inspection apparatus;

FIG. 7 explains defect-position coordinate data read in at the time of an inspection;

FIG. 8 schematically shows a die which is to be inspected;

FIG. 9 shows an example of data file corresponding to the die shown in FIG. 8;

FIG. 10 is a three-dimensional map of distance sensor sensitivity when the distance sensor's sensitivity is uniform over the sensor area;

FIG. 11 is a three-dimensional map of distance sensor sensitivity when the distance sensor's sensitivity varies in the sensor area;

FIG. 12 is a perspective view of an actual convex pattern as an example;

FIG. 13 is a perspective view of a false shape which would be when the distance sensor recognizes the convex pattern in FIG. 12;

FIG. 14 is a side elevation showing the relation in shape between the actual convex pattern shown in FIG. 12 and the false shape the distance sensor recognizes, shown in FIG. 13;

FIG. 15 explains a correction value C2; and

FIG. 16 shows another example of the data file describing the shape of a convex or concave pattern.

### DETAILED DESCRIPTION OF THE PREFERRED EMBODIMENTS

The present invention will be described herebelow concerning an inspection apparatus according thereto for inspection of a device pattern formed on a semiconductor wafer. However it should be noted that the present invention is not limited to the inspection apparatus which will be described but it is widely applicable to a technology in which a distance sensor is used to focus an objective lens relative to an object under inspection and which has a convex or concave pattern.

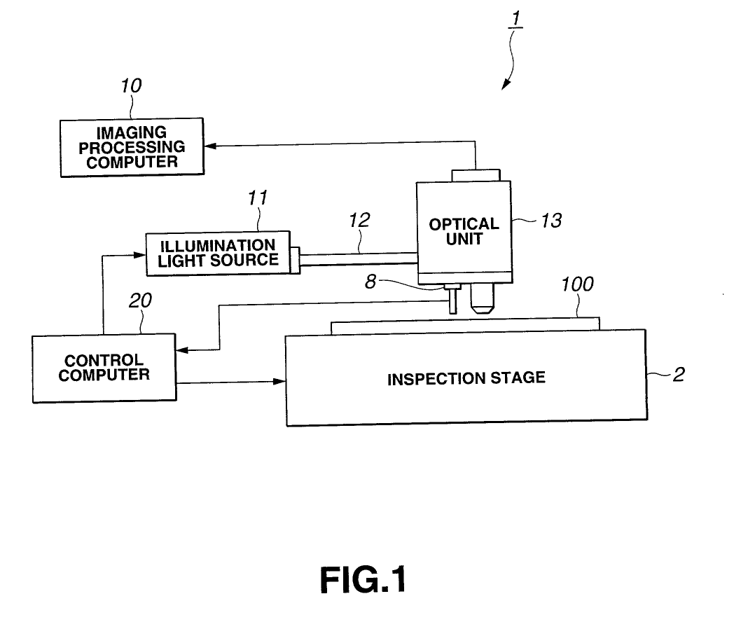

Referring now to FIG. 1, there is schematically illustrated in the form of a block diagram the inspection apparatus according to the present invention. The inspection apparatus is generally indicated with a reference 1, and includes an inspection stage 2 on which a semiconductor wafer 100 to be inspection is placed. The inspection stage 2 supports the semiconductor wafer 100 under inspection and functions to move the supported semiconductor wafer 100 so that each of inspecting points on the semiconductor wafer 100 goes to a predetermined inspection post.

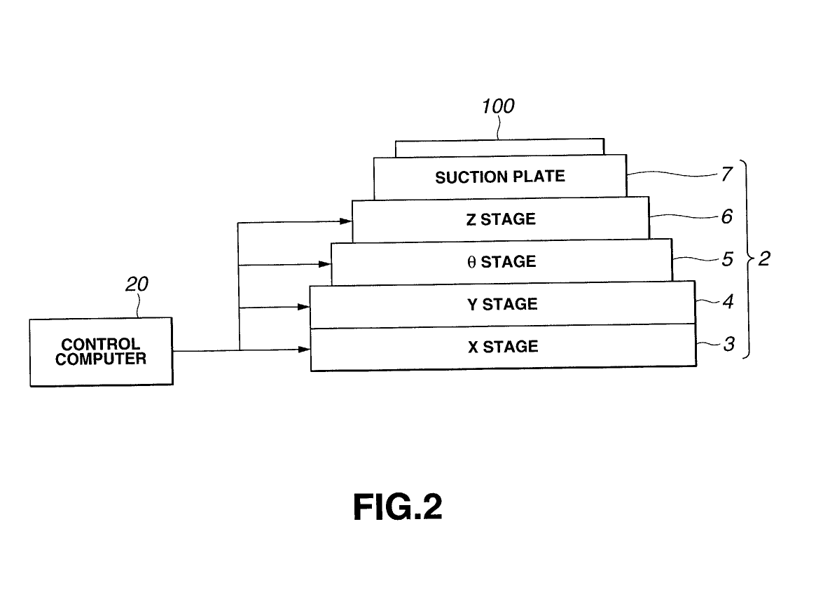

More specifically, the inspection stage 2 includes an X stage 3, a Y stage 4 provided on the X stage 3, a è stage 5 disposed on the Y stage 4, a Z stage 6 provided on the è stage 5, and a suction plate 7 disposed on the Z stage 6, as shown in FIG. 2.

The X and Y stages 3 and 4 are horizontally movable and so arranged as to be moved in directions perpendicular to each other, respectively. For inspection of the semiconductor wafer 100, the X and Y stages 3 and 4 move the semiconductor wafer 100 horizontally under the control of a control computer 20 so that each of the inspecting points goes to the predetermined inspection post.

The è stage 5 is a so-called rotating stage to rotate the semiconductor wafer 100. For the inspection of the semiconductor wafer 100, the è stage 5 rotates the semiconductor wafer 100 in an in-plane direction under the control of the control computer 20 so that an image of the inspecting point is horizontal on, or perpendicular to, an inspection monitor screen.

The Z stage 6 is movable vertically to move the semiconductor wafer 100 in the height direction. The Z stage 6 is made of PZT (lead titanate zirconate) for example, and designed so that a height adjustment can properly be made as finely as less than 0.1 μm. For the inspection of the semiconductor wafer 100, the Z stage 6 moves the semiconductor wafer 100 in the height direction under the control of the control computer 20 to adjust the height of the inspection post very finely.

The suction plate 7 fixes the semiconductor wafer 100 by sucking. For the inspection of the semiconductor wafer 100, the latter is disposed on the suction plate 7. The semiconductor wafer 100 is thus sucked and fixed by the suction plate 7.

The inspection stage 2 constructed as in the above should desirably be disposed on a vibration isolation bench in order to control an external vibration or a vibration created when the inspection stage 2 is moved. Especially, since the inspection apparatus 1 uses an ultraviolet light to inspect a semiconductor wafer with a high resolution, even a slight vibration will adversely affect the inspection in some cases. For a proper inspection by controlling the influence of such a vibration, it is very effective to place the inspection stage 2 on an active vibration isolation bench or the like which will detect a vibration and acts in a direction of canceling the vibration for example.

The inspection apparatus 1 according to the present invention includes also an illumination light source 11 which emits an illumination light to the semiconductor wafer 100 placed on the inspection stage 2. In an inspection apparatus for optical inspection of an object, the resolution of the inspection depends upon the wavelength of an illumination light incident upon the object under inspection, and the shorter the waveform of the illumination light, the higher the inspection resolution will be. In this inspection apparatus 1, an ultraviolet laser source which emits a light having a wavelength falling within the ultraviolet domain is used as the illumination light source 11. More specifically, the illumination light source 11 is constructed to emit a deep-ultraviolet laser having a wavelength of 266 nm which is four times longer than the wavelength of the YAG laser, for example.

The illumination light source 11 operates under the control of the control computer 20. For the inspection of the semiconductor wafer 100, a deep-ultraviolet laser whose amount is controlled by the control computer 20 is emitted as an illumination light from the illumination light source 11. The illumination light emitted from the illumination light source 11 (will be referred to as “ultraviolet illumination light” hereunder) will be guided through an ultraviolet optical fiver 12, for example, to an optical unit 13 disposed above the inspection stage 2.

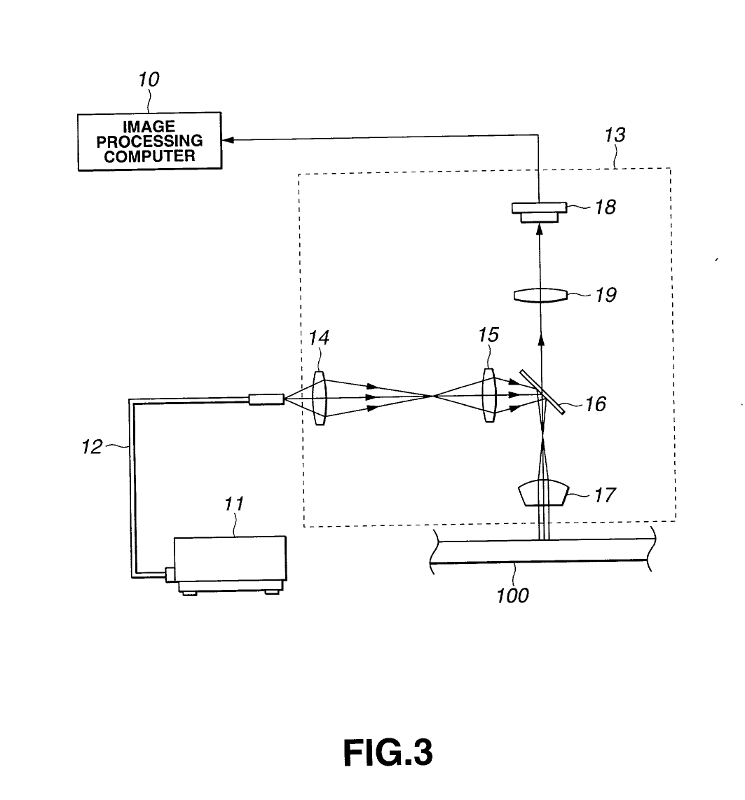

As shown in FIG. 3, the optical unit 13 has an illumination optical system composed of two lenses 14 and 15. The ultraviolet light emitted from the illumination light source 11 and guided through the ultraviolet optical fiber 12 to the optical unit 13 will first be incident upon the illumination optical system. There is provided a half mirror 16 in the optical path of the ultraviolet illumination light having passed through the illumination optical system, and the ultraviolet illumination light reflected from the half mirror 16 will be incident upon an ultraviolet light objective lens 17.

The ultraviolet light objective lens 17 is a lens designed to represent an optimum imaging characteristic to the ultraviolet light, and disposed opposite to the semiconductor wafer 100 placed on the inspection stage 2. Thus, the inspecting point on the semiconductor wafer 100 on the inspection stage 2 will be illuminated with the ultraviolet illumination light incident upon, and converged by, the ultraviolet objective lens 17.

An image of the inspecting point on the semiconductor wafer 100, illuminated with the ultraviolet illumination light, is magnified by the ultraviolet objective lens 17 and picked up by an ultraviolet CCD camera 18. That is, the reflected light from the inspecting point on the semiconductor wafer 100, illuminated with the ultraviolet illumination light, will be incident upon the ultraviolet CCD camera 18 through the ultraviolet objective lens 17, half mirror 16 and an imaging lens 19. Thus, the magnified image of the inspecting point on the semiconductor wafer 100 will be picked up by the ultraviolet CCD camera 18.

The image of the inspecting point on the semiconductor wafer 100, picked up by the ultraviolet CCD camera 18, is sent to an image processing computer 10. In the inspection apparatus 1, the image is processed and analyzed by the image processing computer 10, thereby checking for any defect, wire width anomaly or the like in a device pattern formed on the semiconductor wafer 100.

Also in this inspection apparatus 1, a distance sensor 8 is provided between the ultraviolet objective lens 17 of the optical unit 13 and the semiconductor wafer 100 placed on the inspection stage 2 to measure a distance between them. As the distance sensor 8, a capacitance sensor is used for example. The capacitance sensor measures a capacitance between itself and the object under inspection. Thus, the distance sensor 8 measures the distance between itself and the object under inspection without any contact with the object to provide a voltage corresponding to the measured distance.

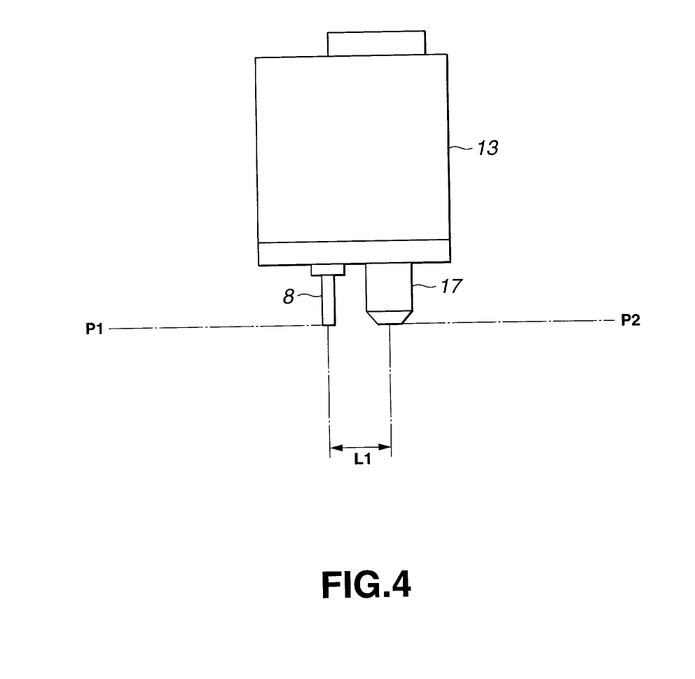

The distance sensor 8 is provided in a fixed geometric relation to the ultraviolet objective lens 17. For example, the distance sensor 8 is installed to the optical unit 13 adjacently to the ultraviolet objective lens 17 in such a manner that a height P1 of its tip coincides with a height P2 of the surface of the ultraviolet objective lens 17 opposite to the semiconductor wafer 100, as shown in FIG. 4. According to the present invention, the distance sensor 8 is at a horizontal distance L1 of about 2.5 cm for example from the ultraviolet objective lens 17.

With the inspection apparatus 1, the distance between the ultraviolet objective lens 17 and semiconductor wafer 100 is determined based on an output from the distance sensor 8 to automatically focus the ultraviolet objective lens 17. The automatic focusing of the ultraviolet objective lens 17 by using the distance sensor 8 will further be described later.

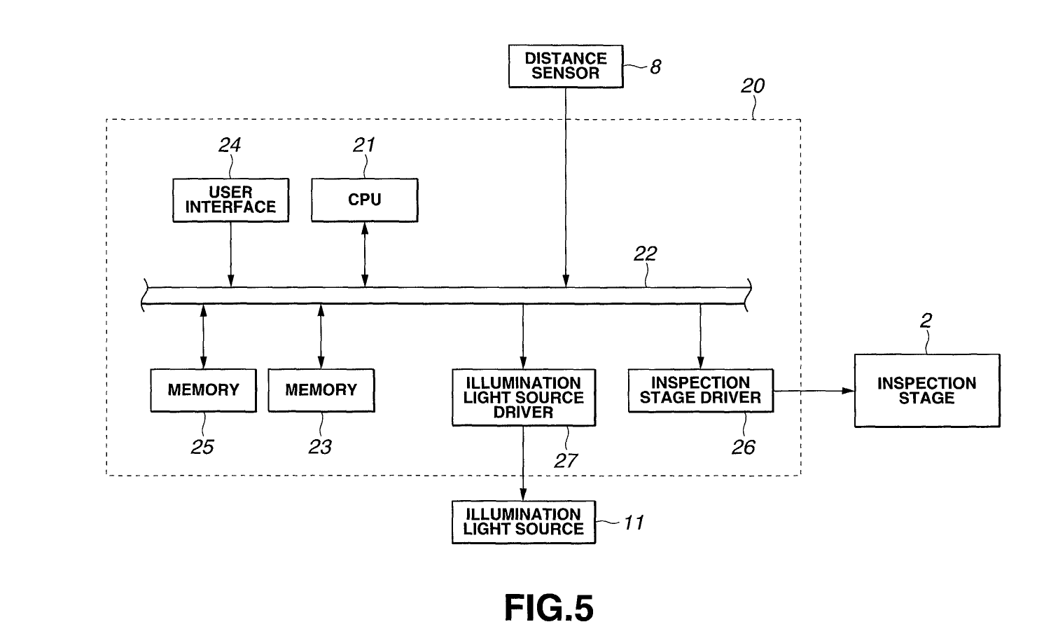

In the inspection apparatus 1, the output from the distance sensor 8 is supplied to the control computer 20. This control computer 20 is provided to control the operation of each component of the inspection apparatus 1, and includes a CPU (central processing unit) 21 as shown in FIG. 5. A memory 23 is connected to the CPU 21 via a bus 22. The CPU 21 uses the memory 23 as a work area to control the operation of each component of the inspection apparatus 1.

More specifically, the CPU 21 is supplied with a user's instruction, output of the distance sensor 8, information stored in a memory 25 or the like, via a user interface 24. Based on such data, it generates a control signal for controlling the inspection stage 2, and supplies it to an inspection stage driver 26. Also, the CPU 21 generates a control signal for controlling the illumination light source 11 and supplies it to an illumination light source driver 27.

The inspection stage driver 26 controls the movement of the inspection stage 2 according to the control signal supplied from the CPU 21. Thus, an inspecting point in the semiconductor wafer 100 placed on the inspection stage 2 will be positioned at the predetermined inspection post. Also, the distance between the semiconductor wafer 100 on the inspection stage 2 and the ultraviolet objective lens 17 of the optical unit 13 will be adjusted to automatically focus the ultraviolet objective lens 17.

The illumination light source driver 27 controls the illumination light source 11 according to the control signal supplied from the CPU 21. Thus, an ultraviolet illumination light will be emitted in a controlled amount from the illumination light source 11.

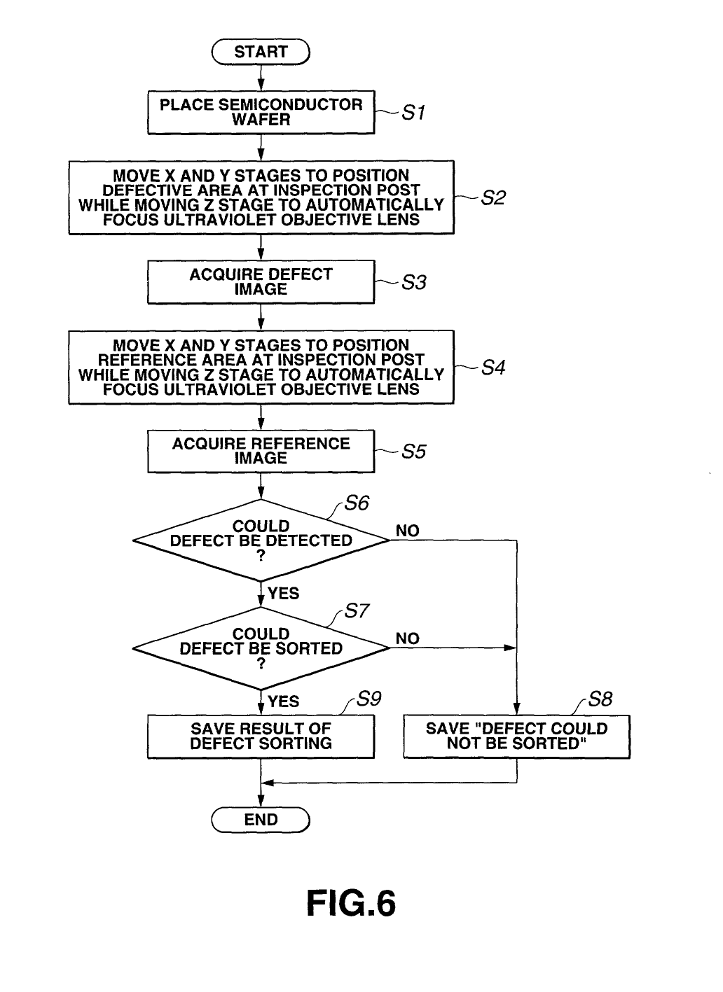

Referring now to FIG. 6, there is shown a flow chart of operations effected in an inspection, by the inspection apparatus 1 constructed as in the above, of a device pattern formed on the semiconductor wafer 100. It is assumed here that the semiconductor wafer 100 has many similar device patterns formed thereon and defect detection and sorting are made through comparison between an image of an area where there exists a defect (will be referred to as “defect image” hereunder) and an image of other area where there exists no defect (will be referred to as “reference image” hereunder).

For inspecting the device pattern formed on the semiconductor wafer 100 by means of the inspection apparatus 1, first the semiconductor wafer 100 is placed on the inspection stage 2 at step S1.

Next at step S2, the X and Y stages 3 and 4 of the inspection stage 2 are moved under the control of the control computer 20 in such a manner that an area on the semiconductor wafer 100 where a defect exists (will be referred to as “defective area” hereunder) is positioned at the predetermined inspecting post of the inspection apparatus 1. Also, the Z stage 6 of the inspection stage 2 is moved under the control of the control computer 20 for an automatic focusing of the ultraviolet objective lens 17 to the defective area on the semiconductor wafer 100. The positioning of the defective area and automatic focusing of the ultraviolet objective lens 17 will further be described later.

Next at step S3, the illumination light source 11 is driven under the control of the control computer 20 to emit an ultraviolet illumination light. The ultraviolet illumination light emitted from the illumination light source 11 is guided through the ultraviolet optical fiber 12 to the optical unit 13 and projected upon the defective area on the semiconductor wafer 100. Ann image of the defective area (defect image) thus illuminated with the ultraviolet illumination light is picked up by the ultraviolet CCD camera 18, and sent to the image processing computer 10.

Next at step S4, the X and Y stages 3 and 4 of the inspection stage 2 are moved under the control of the control computer 20 in such a manner that an area on the semiconductor wafer 100 where no defect exists (will be referred to as “reference area” hereunder) is positioned at the predetermined inspection post of the inspection apparatus 1. Also, the Z stage 6 of the inspection stage 2 is moved under the control of the control computer 20 for automatic focusing of the ultraviolet objective lens 17 to the reference area on the semiconductor wafer 100. Note that the positioning of the reference area and automatic focusing of the ultraviolet objective lens 17 are the same as those effected at step S2.

Next at step S5, the illumination light source 11 is driven under the control of the control computer 20 to emit an ultraviolet illumination light. The ultraviolet illumination light emitted from the illumination light source 11 is guided through the ultraviolet optical fiber 12 to the optical unit 13 and projected upon the defective area on the semiconductor wafer 100. Ann image of the reference area (reference image) thus illuminated with the ultraviolet illumination light is picked up by the ultraviolet CCD camera 18, and sent to the image processing computer 10.

Next at step S6, the defect image acquired at step S3 and reference image acquired at step S5 are compared with each other by the image processing computer 10 to detect a defect from the defect image. When a defect could be detected from the defect image at this step S6, the operation goes to step S7. On the contrary, when no defect could be detected at step S6, the operation goes to step S8.

At step S7, the image processing computer 10 examines what the defect having been detected at step S6 is and sorts it. When the defect could be sorted at step S7, the operation goes to step S9. On the contrary, when the defect could not be sorted, the operation goes to step S8.

At step S9, the result of the defect sorting is stored and the inspection for any defect in the device pattern formed on the semiconductor wafer 100 is complete. The defect sorting defect is stored in a memory connected to the image processing computer 10 for example. Also, the defect sorting result may be transferred to any other computer connected to the image processing computer 10 via a network.

On the other hand, at step S8, information indicating that the defect could not be sorted is stored and the inspection for any defect in the device pattern formed on the semiconductor wafer 100 is complete. The information indicating that the defect could not be sorted is stored the memory connected to the image processing computer 10 for example. Also, the information may be transferred to the other computer connected to the image processing computer 10 via the network.

The positioning of the defective area at the inspection post and automatic focusing of the ultraviolet objective lens 17, effected at step S2, will be described in further detail herebelow. Note that also at step S4, there are effected similar operations to those which will be described below.

For positioning of the defective area to the inspection post and automatic focusing of the ultraviolet objective lens 17, first defect's position coordinate information is read into the control computer 20. The defect's position coordinate information indicates the position coordinate of a defect in the semiconductor wafer 100. It is prepared by detecting the defect in the semiconductor wafer 100 in advance by another apparatus. The defect's position coordinate information is supplied to the control computer 20 of the inspection apparatus 1 from the user or a host computer controlling an entire production facility, and stored into the memory 25 of the control computer 20.

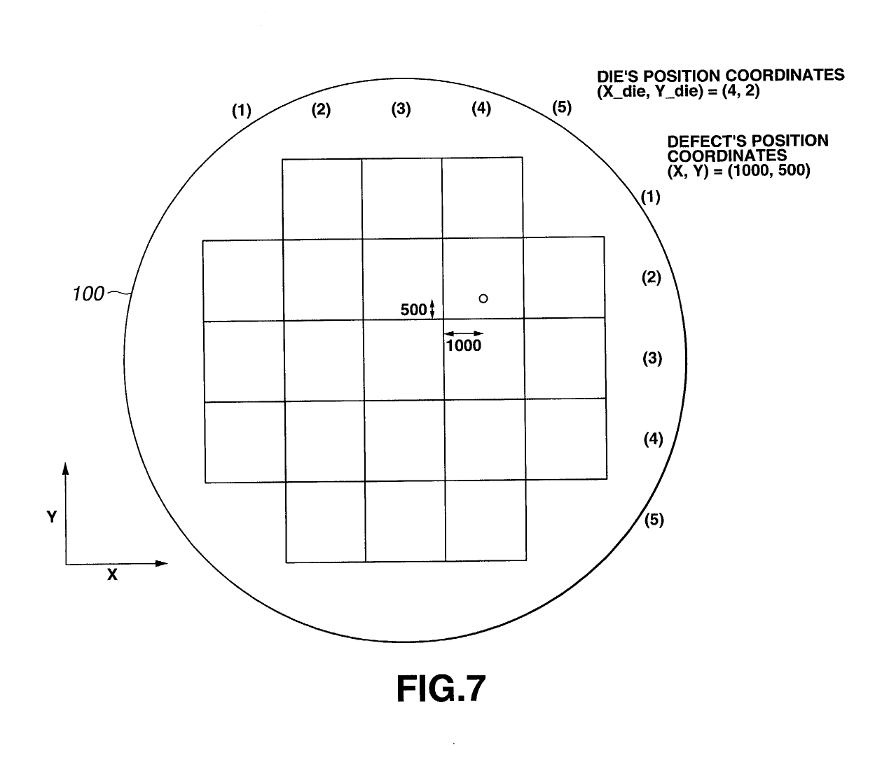

More particularly, the defect's position coordinate information is described with coordinates with respect to the size of a die in a pattern formed on the semiconductor wafer 100. As shown in FIG. 7 for example, the information is represented by die position coordinates (X_die, Y_die) of a die in the semiconductor wafer 100 and defect's position coordinates (X, Y) with respect to the origin of the die.

Note that in this embodiment, to inspect the device pattern formed on the semiconductor wafer 100 for any defect, the defect's position coordinate information indicative of the position coordinates of the defect is read into the control computer 20. However, for measuring the wire width or the like of an exposure pattern to evaluate the performance of an exposure apparatus for example, measured position coordinate information indicative of position coordinates of the exposure pattern whose wire width is to be measured will be read, instead of the defect's position coordinate information, into the control computer 20. The measured position coordinate information is also described with coordinates with respect to the size of a die in a pattern formed on the semiconductor wafer 100, for example.

After the defect's position coordinate information is read into the control computer 20, the CPU 21 of the control computer 20 generates, based on the defect's position coordinate information stored in the memory 25, a control signal intended for controlling the inspection stage 2, and supplies it to the inspection stage driver 26. According to the supplied control signal, the inspection stage driver 26 drives the X and Y stages 3 and 4 of the inspection stage 2 to move the semiconductor wafer 100 horizontally for the defective area to enter a measuring area of the distance sensor 8 (will be referred to “measuring view field of the distance sensor 8” hereunder).

After the defective area enters the measuring view field of the distance sensor 8, the control computer 20 generates, based on the output from the distance sensor 8, a control signal intended for controlling the inspection stage 2 and supplies it to the inspection stage driver 26. According to the supplied control signal, the inspection stage driver 26 drives the Z stage 6 of the inspection stage 2 to control the height of the Z stage 6 for the distance between the defective area and distance sensor 8 to be a specific one.

For setting the specific distance, a correction value C3 is added to compensate for a drift of the output of the distance sensor 8. That is, when the aforementioned capacitance sensor is used as the distance sensor 8, the output from the capacitance sensor will drift with an environmental change such as a change of the outside air temperature or the like. Therefore, a temperature change taking place in the inspection apparatus 1 will cause the output of the distance sensor to be erroneous and the error will gradually be larger with time elapse. To avoid this, the correction value C3 is added to an apparent target distance determined correspondingly to the output from the distance sensor 8, and the result of the addition is set as the specific distance to compensate for the drift of the output of the distance sensor 8.

After the height control is made for the distance between the defective area and distance sensor 8 to be the specific one, the X and Y stages 3 and 4 of the inspection stage 2 are moved again by the inspection stage driver 26 to horizontally move the semiconductor wafer 100 so that the defective area enters the view field of the ultraviolet objective lens 17 while the distance between the defective area and distance sensor 8 is being kept to be the specific one.

After the defective area enters the view field of the ultraviolet objective lens 17, the defect's position coordinates (X, Y) with respect to the die origin are taken as a parameter to calculate a correction value C2 intended to compensate for the influence of a step in the die. The CPU 21 of the control computer 20 calculates, based on a correction value table stored in the memory 25, a correction value C1 intended for compensating for the influence of an inclination or the like of the inspection stage 2. The correction value table has been prepared in advance with the information such as the inclination or the like of the inspection stage 2 being set to correspond to the XY coordinates, and stored in the memory 25.

The CPU 21 generates a control signal corresponding to the correction values C2 anc C1 , and supplies them to the inspection stage driver 26. According to the supplied control signal, the inspection stage driver 26 drives again the Z stage 6 of the inspection stage 2 to adjust the distance between the defective area and ultraviolet objective lens 17 which will thus automatically be focused.

The correction value C2 is intended to compensate for the influence of a step taking place between convex or concave patterns formed in a die to be inspected and which is larger than the focal depth of the ultraviolet objective lens 17. That is, dies to be inspected include ones in which convex or concave patterns are formed such as “LSI in which DRAM and logic are combined in a single ship”. In such an LSI, the DRAM part is more convex than the logic part and the step between these parts is larger than the focal depth of the ultraviolet objective lens 17 in some cases. If the step portion is included in the measuring view field of the distance sensor 8, the apparent target distance determined correspondingly to the output from the distance sensor 8 will be influenced by the step portion and thus deviate much from a real target distance, causing the ultraviolet objective lens 17 to be out of focus. For the automatic focusing of the ultraviolet objective lens 17, the correction value C2 is calculated correspondingly to the height at each point within a die to be inspected, and the distance between the defective area and ultraviolet objective lens 17 is adjusted according to the correction value C2 to compensate for the influence of a step in the die.

The correction value C1 is intended to compensate for the influence of an inclination or the like of the inspection stage 2 due to the fact that the distance sensor 8 and ultraviolet objective lens 17 are apart from each other. That is to say, since the distance sensor 8 is disposed horizontally apart about 2.5 cm from the ultraviolet objective lens 17 as having been described in the foregoing, if the inspection stage 2 is inclined or distorted when the X and Y stages 3 and 4 thereof are moved, the distance between the defective area and distance sensor 8 will not coincide with that between the defective area and ultraviolet objective lens 17 and the deviation will vary depending upon the moving distance of the X and Y stages 3 and 4. Thus, the ultraviolet objective lens 17 will be out of focus as the case may be. For focusing the ultraviolet objective lens 17, the correction value C1 is calculated based on a correction table prepared with the information of the inclination or the like of the inspection stage 2 being set to correspond to the XY coordinates, and the distance between the defective area and ultraviolet objective lens 17 is adjusted according to the correction value C1 , thereby compensating for the influence of the inclination or the like of the inspection stage 2, caused by a geometry in which the distance sensor 8 and ultraviolet objective lens 17 are apart from each other.

As in the foregoing, when the distance between the defective area and ultraviolet objective lens 17 is adjusted and the ultraviolet objective lens 17 is automatically focused, a defect image is picked up bu the ultraviolet CCD camera 18, and sent to the image processing computer 10 which will properly detect and sort a defect.

To calculate the correction value C2 for compensating for the influence of the step in the die, a correction data file in which the correction value C2 corresponding to each coordinate in the die is directly described may be prepared, stored in the memory 25 of the control computer 20 for example, and read out of the correction data file as necessary. In this case, since the DRAM and logic parts of the “LSI in which the DRAM and logic are combined in a single chip” are by about 1 μm different in height discretely from each other, the correction data file will reflect the local variation in height and discretely vary at the step portion.

To determine the correction value C2 at an arbitrary position from a limited number of data, it is necessary to calculate the correction value C2 by primary interpolation or spline interpolation. In there exist discrete points as in the above, however, many data should be prepared in advance in order to calculate a correct correction value C2 by making an accurate interpolation. For example, in case the view field of the ultraviolet objective lens 17 has a size of about 50 μm×50 μm, 40,000 (=200×200) pieces of data per die are required for the correction data file in order to calculate an accurate correction value C2 for a die of about 10 mm×10 mm with a resolution of such a view field size.

However, it is substantially difficult to prepare in advance such a large amount of data as the correction data file, and such a calculation of the correction value C2 cannot flexibly deal with a change in design of the device pattern.

According to the present invention, the correction value C2 is accurately calculated based on a minimum amount of data with which the shape of patterns in the die is described to properly compensate for the influence of the step in the die without the necessity of preparing any large amount of data and while flexibly dealing with a change in design, whereby it is made possible to automatically focus the ultraviolet objective lens 17.

The calculation of the correction value C2 intended to compensate for the influence of a step in the die will be described in detail herebelow.

According to the present invention, there is calculated a difference between the real shape of a convex or concave pattern of each die formed on the semiconductor wafer 100 to be inspected and the shape (false one) of a convex or concave pattern recognized by the distance sensor 8, and it is taken as the correction value C2. Thus, it is possible to measure the distance between the distance sensor 8 limited in spatial resolution and a defective area in the die and automatically focus the ultraviolet objective lens 17. The “spatial resolution” represents how many smallest increments in distance can be distinguished in measuring a distance from an area. A distance sensor having a high spatial resolution can measure a distance at each very narrow area like the view field size of the ultraviolet objective lens 17 for example. For the purpose of describing a measurement of a distance between the distance sensor 8 and an inspecting point in a die for which the distance sensor 8 is limited in spatial resolution, it will be assumed for example that the view field of the ultraviolet objective lens 17 is approximately 50 μm×50 μm in size and the distance sensor 8 is to measure an area of about 3 mm in diameter (measuring view field).

According to the present invention, the correction value C2 is calculated as in the following procedure. That is, in a procedure 1, there is prepared a function f(x, y) representing the shape (contour and step height) of convex or concave pattern of a die. The “contour” of the convex or concave pattern is a one recognized when the pattern is represented in the form of a plan view. In a procedure 2, there is prepared a function g(X, Y) representing a spatial sensitivity distribution of the distance sensor 8. In a procedure 3, there is calculated a false shape h(x, y) of the convex or concave pattern recognized by the distance sensor 8 by integrating the product of the functions f(x, y) and g(X. Y) by an area defined by the function g(X, Y). This procedure is called “convolution”. Next in a procedure 4, a correction value C2 intended for compensating for the influence of a step in a die is calculated from a difference between the functions f(x, y) and h(x, y). By the calculation of the correction value C2 through the above procedures, the correction value C2 can be calculated accurately based on a minimum amount of data. Each of the above procedures will be described in detail herebelow:

Procedure 1

First, the function f(x, y) representing the shape of convex or concave pattern of a die will be described. To obtain this function f(x, y), a data file defining the shape of convex or convex pattern is prepared in advance and stored in the memory 25 of the aforementioned control computer 20 for example. In the data file, for example, positions X1, Y1, X2 and Y2 are taken as one unit, and a rectangular area taking as a diagonal a line connecting coordinates (X1, Y1) and (X2, Y2) is defined as a contour of the convex or concave pattern. A step between the convex or concave pattern and its surrounding area is described as “h” and the convex or concave pattern is defined to be higher or lower by “h” than its surrounding area. Each of the coordinates is described with a coordinate system taking as an origin (0, 0) a corner of a die in which a convex or concave pattern is formed. Note that each convex or concave pattern defined by the coordinate system does not overlap another.

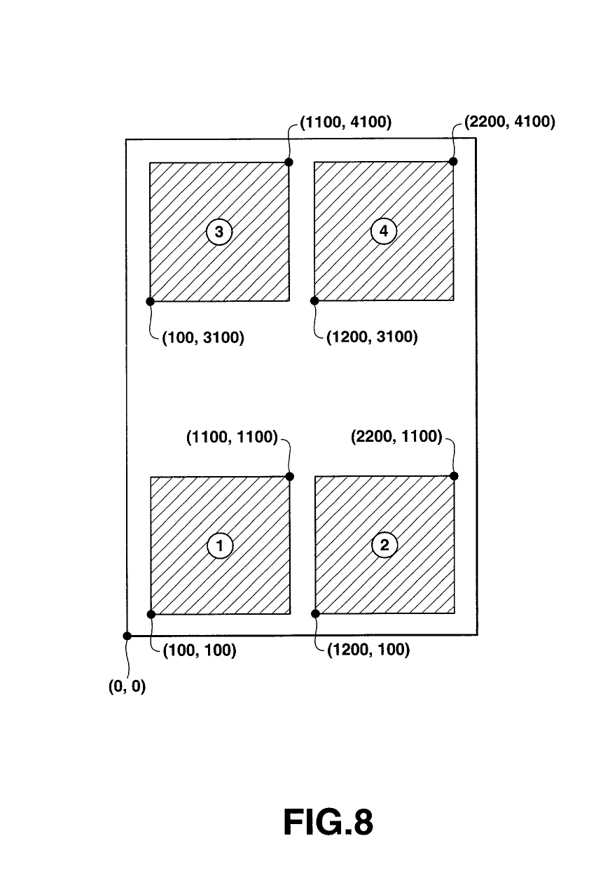

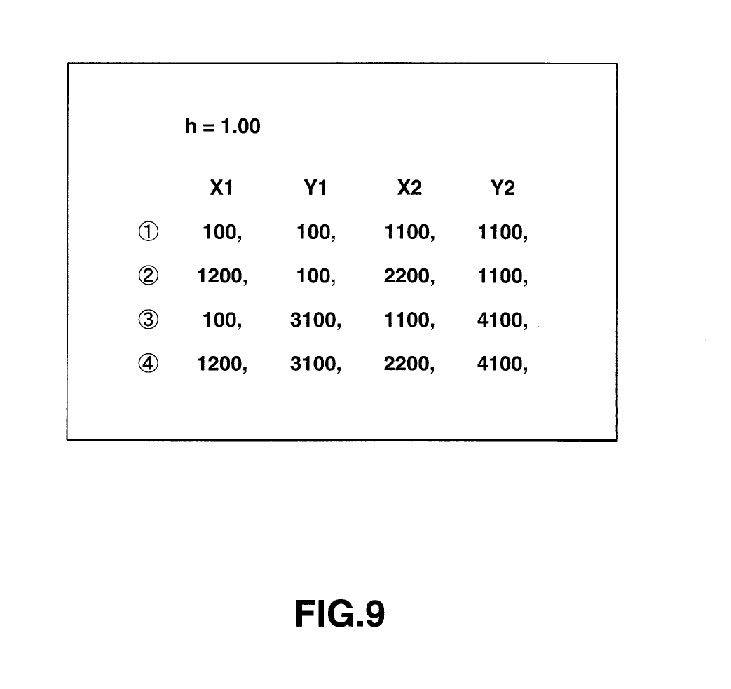

More particularly, a data file defining the shape of the DRAM part being a convex part in an “LSI in which DRAM and logic are combined in a single chip” as shown in FIG. 8 for example is described in a form shown in FIG. 9, and stored in the memory 25 of the control computer 20. Note that in the “LSI in which DRAM and logic are combined in a single chip” shown in FIG. 8, the hatched areas indicate the DRAM parts and the DRAM parts are about 1 μm higher than the logic part. Each of the coordinates is represented in micro meters (μm).

The function f(x, y) is defined based on such a data file so that f(x, y)=h when the coordinates (x, y) are in the rectangular area representing a contour of a convex or concave pattern while f(x, y)=0 when the coordinates (x, y) are outside the rectangular area.

Procedure 2

Next, the function g(X, Y) representing the spatial sensitivity distribution of the distance sensor 8 will be explained. This function g(X, Y) indicates how sensitive the distance sensor 8 being a capacitance sensor has at each of coordinates (X, Y) whose origin (0, 0) is the center of the opposite end face of the distance sensor 8 to the semiconductor 100. For example if the distance sensor 8 has a uniform sensitivity over a detecting area having a radius r, the function g(X, Y) is defined by an expression (1) below:

$$g ( X , Y ) = \frac{1}{π {r}^{2}} , ( {X}^{2} + {Y}^{2} \leq {r}^{2} ) = 0 , ( {X}^{2} + {Y}^{2} \geq {r}^{2} ) \qquad ( 1 )$$

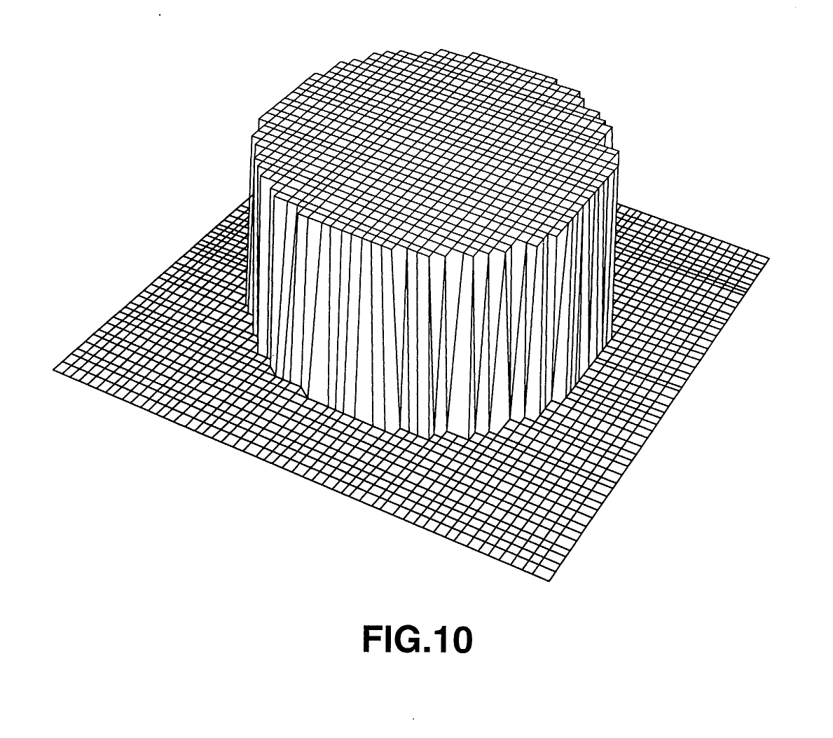

The function g(X, Y) is so standardized that when integrated with the entire detecting area of the distance sensor 8, it will be g(X, Y)dXdY=1 . The spatial sensitivity distribution of the distance sensor 8 represented by the function g(X, Y) defined by the expression (1) is graphically illustrated in FIG. 10.

Also, if the sensitivity of the distance sensor 8 is not uniform in the detecting area, a proper function has to be prepared for the spatial sensitivity distribution. However, also in this case, a proper standardization constant has to be set such that the value of the function g(X, Y) integrated with the entire detecting area of the distance sensor 8 becomes 1.

In case the aforementioned capacitance sensor is used as the distance sensor 8, the latter cannot have any uniform sensitivity in the entire detecting area but has a sensitivity distribution gently varying in the detecting area under the fringe effect at the edge of the detecting area in practice. To simulate the real sensitivity distribution of the distance sensor 8, the function g(X, Y) representing the spatial sensitivity distribution of the distance sensor 8 is given by a following expression (2):

$$g ( X , Y ) = \frac{A}{1 + {a ( \frac{\sqrt{{X}^{2} + {Y}^{2}}}{b} )}^{c}} \qquad ( 2 )$$

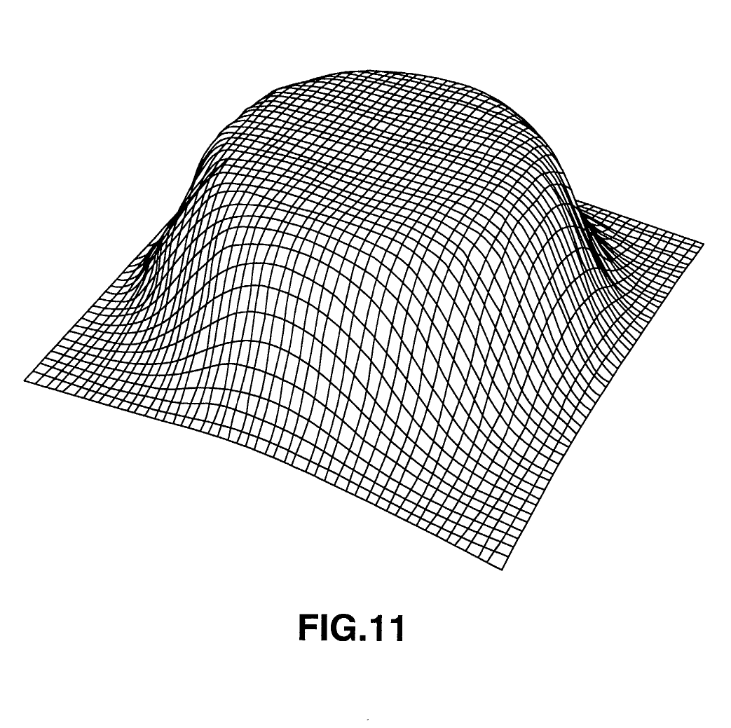

In the expression (2), the terms a, b and c are parameters indicating the size of the detecting area, steepness of change in sensitivity near the edge of the detecting area and the like, and set for a sensitivity distribution approximate to the real one of the distance sensor 8. Also in the expression (2), the term A is a standardization constant. The spatial sensitivity distribution of the distance sensor 8 represented by the function g(X, Y) defined by the expression (2) is graphically illustrated in FIG. 11.

The function g(X, Y) indicating the spatial sensitivity distribution of the distance sensor 8, set as in the above, is stored in the memory 25 of the aforementioned computer 20 for example.

Procedure 3

Next, the false shape h(x, y) of the convex or concave pattern recognized by the distance sensor 8 will be described. The false shape h(x, y) is determined by the CPU 21 of the control computer 20 for example through calculation of a convolution of a function f(x, y) representing the shape of the convex or concave pattern obtained in the procedure 1 and the function g(X, Y) representing the spatial sensitivity distribution of the distance sensor 8, having been obtained in the procedure 2.

Namely, when the distance sensor 8 has a sufficiently high spatial resolution, it will provide a value faithfully reflecting a step of a convex or concave pattern formed in each die on the semiconductor wafer 100. In practice, however, the distance sensor 8 has a limited spatial resolution and the output from the distance sensor 8 will be a value obtained by virtually dividing the detecting area of the distance sensor 8 into micro areas, multiplying the distance between the distance sensor 8 and a die in each micro area by the sensitivity of the distance sensor 8 and averaging the multiplication results. Such a series of operations is just the convolution.

The false shape of the convex or concave pattern calculated by the convolution of the function f(x, y) representing the shape of the convex or concave pattern and the function g(X, Y) representing the spatial sensitivity distribution of the distance sensor 8, that is, the shape h(x, y) of the convex or concave pattern, recognized by the distance sensor 8, is given by a following expression (3):

h(x,y)=∫∫_{detecting area}ƒ(x+X,y+Y)g(X,Y)dXdY (3)

For easier calculation of the false shape h(x, y) of the convex or concave pattern recognized by the distance sensor 8 by the CPU 21 of the control computer 20, the detecting area of the distance sensor 8 is divided into micro areas at intervals d and the term f(x+X, y+Y)g(X, Y) is calculated for each micro area, and the false shape h(x, y) is represented by the sum of the calculated terms. In this case, the function h(x, y) is given by a following expression (4):

$$h ( x , y ) = \frac{1}{{d}^{2}} {\sum }_{m} {\sum }_{n} f ( x + md , y + nd ) g ( md , nd ) \qquad ( 4 )$$

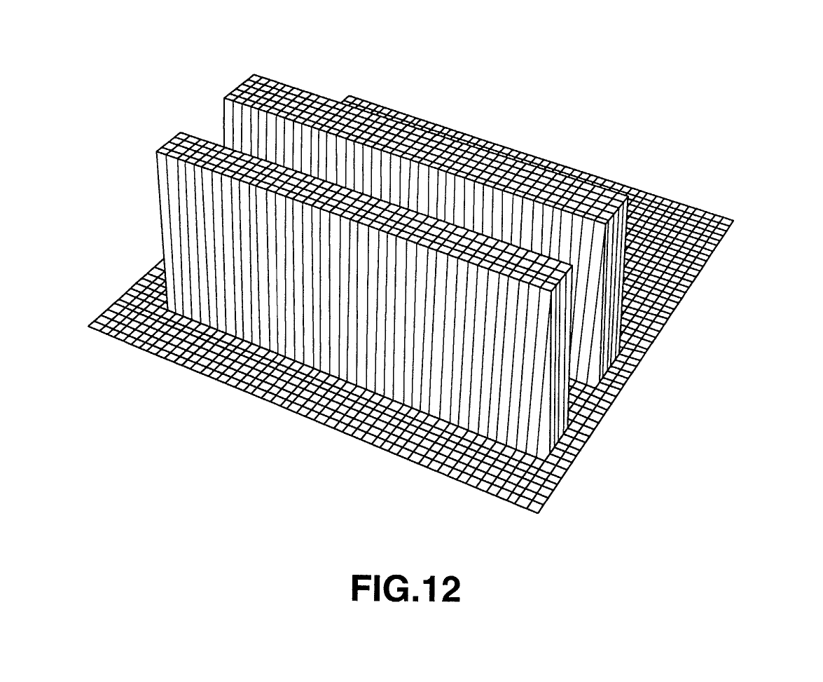

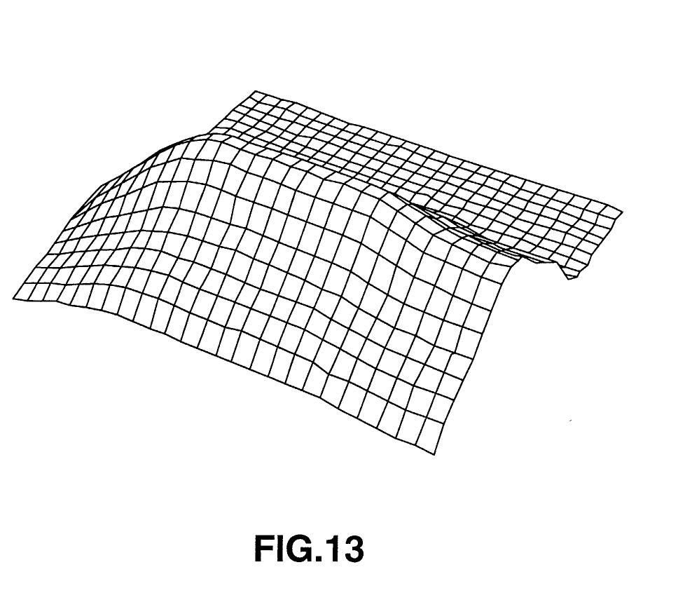

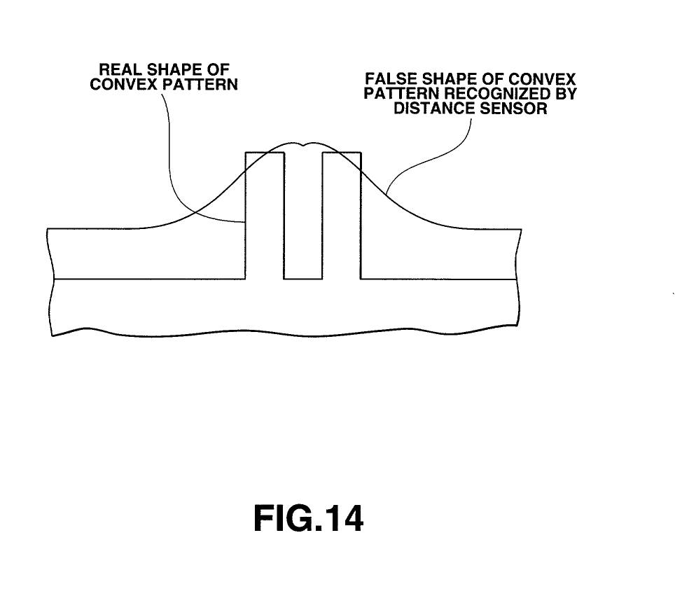

When the real shape of the convex pattern is as shown in FIG. 12, the false shape calculated as in the above and recognized by the distance sensor 8 will be a gentle convex at a portion corresponding to a convex pattern as shown in FIG. 13. The relation between the real shape of the convex pattern shown in FIG. 12 and the false one of the convex pattern for recognition by the distance sensor 8 as shown in FIG. 13 is as shown in FIG. 14.

Procedure 4

Next, how to calculate the correction value C2 intended for compensating for the influence of the step in the die, from the functions f(x, y) and h(x, y) for the target coordinates (x, y) in the die, will be described.

The correction value C2 is determined from a difference between the functions f(x, y) and h(x, y) as given by a following expression (5):

C2=Ah(x, y)−ƒ(x, y)+B (5)

In the expression (5) above, the coefficient A is intended to compensate for a deviation, if any, of the function g(X, Y) representing the spatial sensitivity distribution of the distance sensor 8, having been obtained in the procedure 2, from the real spatial sensitivity distribution of the distance sensor 8.

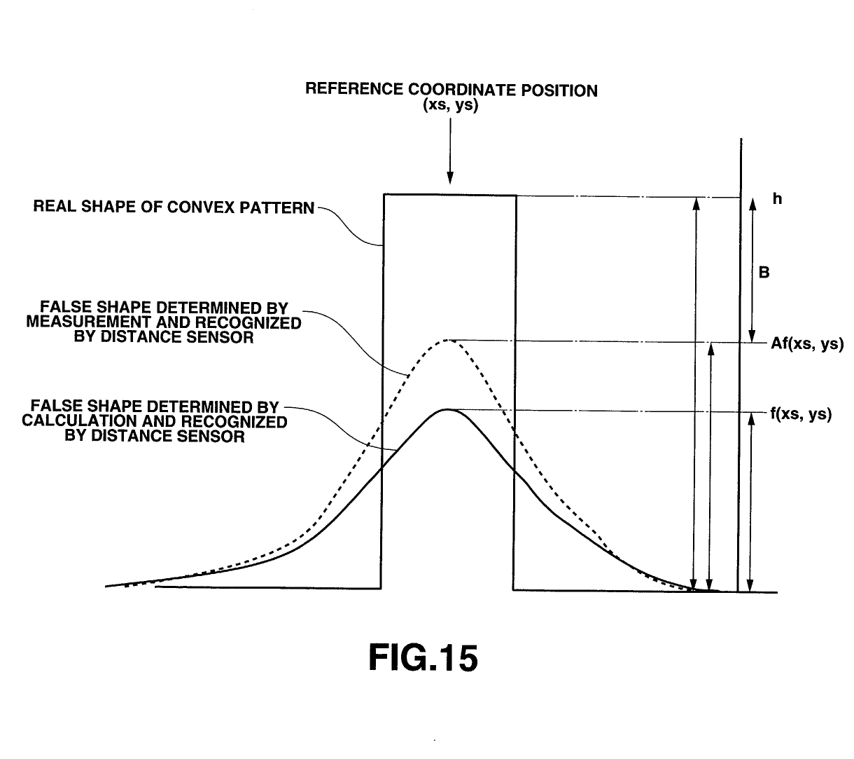

More specifically, the false shape h(x, y) of the convex or concave pattern recognized by the distance sensor 8 is determined through the calculation of a convolution, by the CPU 21 of the control computer 20, of the functions f(x, y) and g(X, Y). However, the false shape h(x, y) recognized by the distance sensor 8, determined by such a calculation, differs from the measured false shape h(x, y) recognized by the distance sensor 8 in some cases as shown in FIG. 15. Such a difference is caused mainly by a deviation of the function g(X, Y) representing the spatial sensitivity distribution of the distance sensor 8 from the real spatial sensitivity distribution of the distance sensor 8. To compensate for such a deviation, the false shape h(x, y) recognized by the distance sensor 8, determined by the above calculation, is multiplied by the coefficient A. Since the deviation is not so large in many cases, the coefficient A will be approximately 1.

In the expression (5), the term B is intended for compensating for a deviation in height between the real convex or concave pattern at a reference coordinate position (Xs, Ys) and the convex or concave pattern at the reference coordinate position (Xs, Ys), recognized by the distance sensor 8, as shown in FIG. 15. Note that in FIG. 15, the central position of the convex pattern having a height h is at the reference coordinate position (Xs, Ys).

For automatic focusing of the ultraviolet objective lens 17, a sum of a fixed target value Ti depending upon the performance of the ultraviolet objective lens 17, correction value C1 for compensating the influence of the inclination or the like of the inspection stage 2, correction value C2 for compensating the influence of the step in the die on the semiconductor wafer 100, and the correction value C3 for compensating for a drift of the output from the distance sensor 8, as given by a following expression (6), is set as a target distance T.

T=Ti+C1+C2+C3 (6)

A difference between a real distance between the ultraviolet objective lens 17 and the semiconductor wafer 100 to be inspected and the target distance T is determined as a target moving distance. Then the Z stage 6 of the inspection stage 2 is moved over determined target moving distance under the control of the control computer 20 until the distance between the ultraviolet objective lens 17 and semiconductor wafer 100 coincides with the target distance T. Thus the ultraviolet objective lens 17 is automatically focused.

The above correction values C1 and C2 are fixed ones depending upon a position on the semiconductor wafer 100 under inspection, while the correction value C3 is intended for compensating for a drift of the output from the distance sensor 8 and can vary every minute correspondingly to an environmental change such as temperature change or the like. Therefore, for correct setting of the correction value C3, it has to be set while the correction values C1 and C2 depending upon a position on the semiconductor wafer 100 under inspection are canceled. To this end, a reference coordinate position (Xs, Ys) is defined and the correction values C1 and C2 are so defined in advance that they will always be 0 at the reference coordinate position. The target distance T at the reference coordinate position (Xs, Ys) is measured, and the correction value C3 is calculated from a difference between the target distance T and fixed target value Ti depending upon the ultraviolet objective lens 17. Thus, only a drift component of the output from the distance sensor 8 can be extracted to correctly set the correction value C3.

The term B in the expression (5) is intended for compensating for a deviation in height between the real convex or concave pattern at the reference coordinate position (Xs, Ys) and the convex or concave pattern at the reference coordinate position (Xs, Ys), recognized by the distance sensor 8, and can be given as given by a following expression (7):

B=ƒ(xs, ys)−Ah(xs, ys) (7)

By determining the correction value C2 for compensating for the influence of the step in the die on the semiconductor wafer 100 through the aforementioned procedures 1 to 4, it is possible to accurately calculate the correct value C2 based on a minimum amount of data with the shape of the pattern in the die has been described. Therefore, it is not necessary to prepare any great amount of data. Also it is possible to properly compensate the influence of the step in the die to provide an accurate automatic focusing of the ultraviolet objective lens 17 while flexibly accommodating any design change.

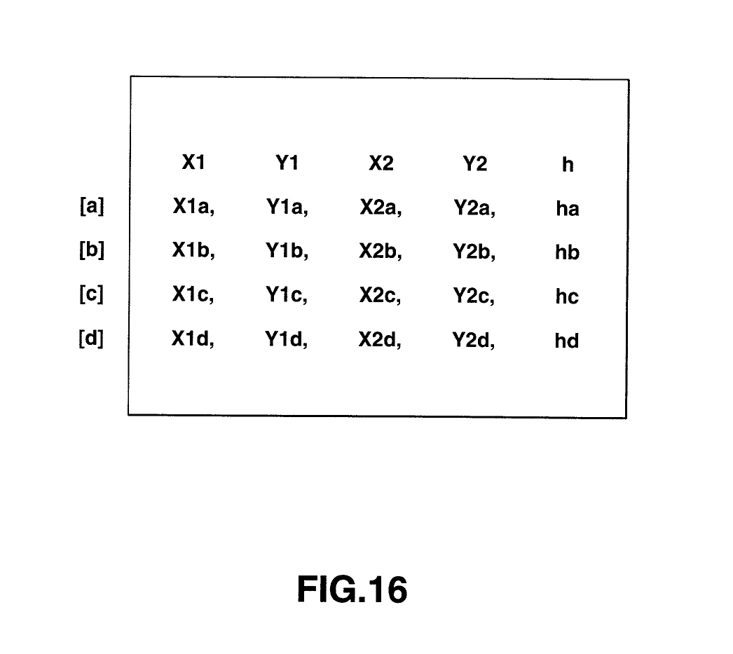

In the foregoing, the method of determining the correction value C2 for compensating for the influence of the step in the die on the semiconductor wafer 100 has been described by way of example on the assumption that convex or concave patterns formed in the dies are formed uniform in height. However, the steps in the dies on some semiconductor wafer 100 to be inspected vary in height from one to another. When an object having steps different in height from each other is to be inspected, it is desired to prepare, as the data file prepared in the procedure 1, a data file described in a form as shown in FIG. 16 instead of the data file described in the form as shown in FIG. 9 and store the data file in the memory 25 of the control computer 20.

As will be seen from the data file shown in FIG. 16, a rectangular area [a] whose diagonal is a line connecting points represented by coordinates (X1a, Y1a) and (X2a, Y2a), respectively, for example, is a contour of a convex or concave pattern forming a step and the height of a step between the convex or concave pattern at its surrounding area surrounding is ha. Based on such a data file, the function f(x, y) is so defined as to be ha when the coordinates (x, y) are in the convex or concave pattern represented by [a]. Thus, the correction value C2 for compensating for the influence of the step can properly be calculated in the same sequence as the aforementioned one also in inspection of an object having steps different in height from each other.

Generally in the “LSI in which DRAM and logic are combined in a single chip”, the DRAM parts being the convex patterns are distributed as two to eight blocks. In this case, by preparing a function representing the shape of the DRAM parts in each block as well as a function representing the shape of each block, it is possible to calculate a false shape h(x, y) recognized by the distance sensor 8 with a reduced computational complexity, which will enable a higher processing speed.

In the calculation of the correction value C2 in the above procedure 4, the function f(x, y) representing the shape of a convex or concave pattern should desirably be a one reproducing in detail the real shape to the maximum in order to obtain an accurate correction value C2. In the calculation of the convolution in the procedure 3, the function f(x, y) representing the shape of a convex or concave pattern may be an approximate one representing the shape of each block since it suffices in many cases to calculate with each of coarse blocks. In case the convex or concave patterns are distributed in some blocks as in the “LSI in which DRAM and logic are combined in a single chip”, it is desired that an approximate function f1(x, y) representing the shape of each block and a function f2(x, y) reproducing in detail the shape of each convex or concave pattern in a block should be prepared as the function f(x, y) representing the shape of a convex or concave pattern, a convolution be calculated in the procedure 3 using the approximate function f1(x, y) representing the shape of each block as given by a following expression (8), and the correction value C2 be calculated in the procedure 4 using the function f2(x, y) reproducing in detail the shape of each convex or concave pattern in the block as given by a following expression (9).

$$h ( x , y ) = \frac{1}{{d}^{2}} {\sum }_{m} {\sum }_{n} f 1 ( x + md , y + nd ) g ( md , nd ) \qquad ( 8 )$$

C2=Ah(x, y)−ƒ2(x, y)+B (9)

In case the convex or concave patterns are distributed in some blocks as in the above, a plurality of the functions f(x, y) representing the shape of the convex or concave pattern can be prepared and used properly to calculate an accurate correction value C2 while reducing the computational complexity for a more rapid processing.

In the foregoing, the convex or concave pattern was assumed to be rectangular like the DRAM in the “LSI in which DRAM and logic are combined in a single chip”, coordinate data of two points representing the convex or concave pattern were described in the data file and the rectangular area whose diagonal is a line connecting the two points was defined as the contour of the convex or concave pattern. However, the contour of the convex or concave pattern may be defined by each element of two-dimensional data divided at regular intervals for example. By defining the convex or concave pattern in this way, it is possible to properly deal with any convex or concave pattern than the rectangular one.

In the foregoing, the present invention has been described in detail concerning an embodiment of the inspection apparatus 1. However, the present invention is not limited to this embodiment but it may be modified in various forms as necessary. For automatic focusing of the ultraviolet objective lens 17, for example, in the inspection apparatus 1, the Z stage 6 of the inspection stage 2 is moved to move the semiconductor wafer 100 under inspection towards or away from the ultraviolet objective lens 17. For this automatic focusing of the ultraviolet objective lens 17, however, the latter may be supported by an actuator and moved towards or away from the semiconductor wafer 100 under inspection. Also, the ultraviolet objective lens 17 may be focused by moving both the semiconductor wafer 100 and ultraviolet objective lens 17 and adjusting the distance between them.

In the foregoing, the present invention has been described concerning an embodiment of the inspection apparatus 1 for inspection of a device pattern formed on the semiconductor wafer 100. However, the present invention is not limited to this embodiment but is widely be applicable to all apparatuses in which an objective lens is focused by the use of a distance sensor. For example, the present invention can effectively be applied to a crystal liquid display inspection apparatus for inspection of the status of a liquid crystal display.

As having been described in the foregoing, according to the present invention, a deviation of the real shape of the convex or concave pattern from that of a convex or concave pattern recognized by the distance sensor is calculated as a correction value, the output of the distance sensor is corrected according to the correction value to determine a target moving distance, and one or both of the objective lens and object to be inspected is moved over the target moving distance towards or away from the other or each other to focus the objective lens. Thus, even when an object having a larger step than the focal depth of the objective lens, the latter can properly be focused using the distance sensor. Also according to the present invention, since the correction value is determined by a numerical calculation, the necessary amount of data for the correction can be reduced and a change in design or the like of the object to be inspected can flexibly be dealt with.

What is claimed is:

1. A focusing control mechanism for focusing an objective lens when observing an object under inspection using the objective lens, the mechanism comprising:
a distance sensor provided in a fixed geometric relation to the objective lens;
a storage means for storing data representing the shape of a convex or concave pattern of the object under inspection and data representing a spatial sensitivity distribution of the distance sensor;
means for moving either or both of the objective lens and object under inspection relatively in direction towards or away from each other; and
means for controlling the operation of the moving means;
the controlling means calculating, based on the data representing the shape of convex or concave pattern of the object under inspection and data representing the spatial sensitivity distribution of the distance sensor, both stored in the storage means, a deviation of the shape of a convex or concave pattern recognized by the distance sensor from the real shape of convex or concave pattern, to provide a correction value, compensating for an output from the distance sensor with the correction value to determine a target moving distance, and controlling the operation of the moving means according to the target moving distance.

2. The mechanism as set forth in claim 1, wherein as data representing a convex or concave pattern of the object under inspection, coordinate data of two points each representing one convex or concave pattern is stored in the storing means; and
the controlling means recognizes a rectangular area whose diagonal is a line connecting the two points as a real contour of the convex or concave pattern.

3. The mechanism as set forth in claim 1, wherein a capacitance sensor is provided as the distance sensor.

4. An inspection apparatus comprising:
an illuminating means for illuminating an object under inspection with an illumination light converged by an objective lens;
an imaging means for imaging the object under inspection; illuminated by the illuminating means;
an inspecting means for processing an image picked up by the imaging means to inspect the object under inspection;
a distance sensor provided in a fixed geometric relation to the objective lens;
a storage means for storing data representing the shape of a convex or concave pattern of the object under inspection and data representing a spatial sensitivity distribution of the distance sensor;
means for moving either or both of the objective lens and object under inspection relatively in direction towards or away from each other; and
means for controlling the operation of the moving means;
the controlling means calculating, based on the data representing the shape of convex or concave pattern of the object under inspection and data representing the spatial sensitivity distribution of the distance sensor, both stored in the storage means, a deviation of the shape of a convex or concave pattern recognized by the distance sensor from the real shape of convex or concave pattern, to provide a correction value, compensating for an output from the distance sensor with the correction value to determine a target moving distance, and controlling the operation of the moving means according to the target moving distance.

5. The apparatus as set forth in claim 4, wherein as data representing a convex or concave pattern of the object under inspection, coordinate data of two points each representing one convex or concave pattern is stored in the storing means; and
the controlling means recognizes a rectangular area whose diagonal is a line connecting the two points as a real contour of the convex or concave pattern.

6. The apparatus as set forth in claim 4, wherein a capacitance sensor is provided as the distance sensor.

7. The apparatus as set forth in claim 4, wherein the illuminating means illuminates the object under inspection with an illumination light having a wavelength falling within an ultraviolet domain.
